(19) United States
(12) Patent Application Publication
(10) Pub. No.: US 2008/0202849 A1
(43) Pub. Date: Aug. 28, 2008

(54) Billboard fall arrest system

(76) Inventors: Michael Russo, Bakersfield, CA (US); Michael Hummel, Littlerock, CA (US)

Correspondence Address: James M. Duncan;Klein, DeNatale, Goldner, Cooper,, Rosenlieb & Kimball, LLP, P.O. Box 11172, Bakersfield, CA, 93389-1172, US

(21) Appl. No.: 12/070,839

(22) Filed: Feb. 20, 2008

Related U.S. Application Data
(60) Provisional application No. 60/902,451, filed on Feb. 20, 2007.

(51) Int. Cl. A62B 35/00; E04G 3/32

(52) U.S. Cl. 182/3; 182/36

(57) ABSTRACT

A billboard fall arrest system comprises a track member which attaches with mounting brackets to either the vertical upright members of the billboard or to the horizontal ledger members. The track member may further comprise extended curved sections which extend into the area of the walkaround catwalk, thereby allowing a worker to be secured to the fall arrest system with a single lanyard while moving to the ladder at the walkaround catwalk. A sliding member slidably engages the track member, where the sliding member travels along or in the track member as the worker moves relative to the track member. A safety line is attached at one end to the sliding member and attached at the other end to a safety harness worn by the worker.

### CROSS-REFERENCE TO RELATED APPLICATION

U.S. Provisional Application No. 60/902,451 for this invention was filed on Feb. 20, 2007, for which application this inventor claims domestic priority.

### BACKGROUND OF THE INVENTION

The present invention relates to personnel safety apparatus for protecting workers from falling from elevated structures. More particularly, this invention relates to a safety system which provides a fall restraint for workers maintaining or repairing a billboard, or applying new vinyl images to the faces of the billboard.

Billboards are commonly elevated above the ground surface in order to provide onlookers with an unobstructed view of the display shown on the billboard face. Typically, a billboard is elevated by means of a column pipe which supports a frame. The frame can be configured in a number of different ways and may have a substantial number of components. The frame comprises vertical uprights and horizontal ledger members which are structural beams. These structural beams support catwalks and the sign face.

Billboards typically have multiple catwalks to allow workers to change the display of the billboard or to perform maintenance on the billboard components, such as repairing lighting systems or replacing structural members damaged by corrosion, wind, etc. Depending on the configuration, a billboard may have multiple catwalks, such as front catwalks, lower rear catwalks, upper rear catwalks and walkaround catwalks. Worker usually gain access to the upper rear catwalk from the lower cat walks by walking to the “walkaround” catwalk and climbing up a ladder which is accessed from the walkaround catwalk.

Billboards are generally set at a relatively substantial height above ground to increase visibility. Because of this height, workers face a risk of falling when installing vinyl displays or conducting various maintenance or repair operations on a billboard. This risk has caused various regulatory agencies, specifically the Occupational Safety and Health Administration (OSHA), to issue various regulations pertaining to safety apparatus required for billboard workers. In general, billboard workers are required, when working on any of the billboard catwalks, to always have a safety lanyard connected to arrest a fall from the catwalk. The worker wears a harness to which one end of the lanyard or safety line is attached. With the known systems, the opposite end of the lanyard is attached to a cable which spans between two of the vertical uprights which comprise some of the structural members of the billboard frame. The lanyard slides along the cable as the worker moves along the catwalk.

The cable fall arrest system presents workers with difficulties in traversing the catwalks and gets in the way as the workers perform their work. The cable does not extend completely across the breadth of the catwalk or along the sides of the billboard adjacent to the walkaround catwalk. Instead, the cable spans between the outermost vertical uprights at the front of the billboard. This configuration makes it awkward for a worker to always have a lanyard connected as required under the regulations. For example, if a worker needs to move from a lower front catwalk to an upper rear catwalk, the worker must first move to a walkaround catwalk to gain access to a ladder by which the worker can climb up to the upper catwalk from the walkaround. However, the cables of the known fall arrest systems, because the cables only span between the outermost uprights, do not extend all of the way to the walkaround catwalk.

OSHA regulations require that a billboard worker always be secured to a fall arrest device while working on a catwalk. Therefore, the accepted practice is for a billboard worker to have two lanyards attached to his or her safety harness, where one of the lanyards is always connected at the other end to the cable or a structural member of the billboard. To gain access to a ladder, the worker ideally moves to the walkaround catwalk with a first lanyard attached to the cable with the lanyard of sufficient length for the worker to reach the ladder. Once at the ladder, the worker attaches the second lanyard to the ladder or other structural member, and then returns to the point where the first lanyard is attached to the cable to disconnect the first lanyard from the cable. Once the first lanyard is disconnected, the worker returns to the ladder for the ascent to the upper catwalk. It is to be appreciated that this is a burdensome process which, predictably, invites some workers to disconnect the first lanyard and move directly to the ladder without being secured by any fall arrest device.

The known system has other deficiencies. Because of its weight and the length it spans, the cable can have a considerable amount of sag between the anchor points at the outermost vertical uprights. Because of this sag, a worker may fall a considerable distance before the fall is arrested by the lanyard attached to the cable. Moreover, if a worker falls, the cable is severely deflected by the impact of the lanyard on the cable, potentially causing other workers tethered to the cable to also fall because of the sudden jolt on the cable. The cable can become snagged or interwoven between various structural members. For example, if lighting components are installed or replaced after the cable has been installed, the lighting components may be placed over or around the cable. In such instances, the worker must continually detach and reattach the safety lanyard to the cable to navigate around such obstructions.

### SUMMARY OF THE INVENTION

The present invention is directed to a fall arrest system which addresses the disadvantages identified above. The present invention is a fall arrest system which utilizes a fixed track mounted to structural members of the billboard to replace the cable of the known systems. A lanyard attachment member slides along or inside the track. The worker's safety lanyard attaches to the lanyard attachment member. Embodiments of the various components of the fall arrest system comprise a track member which may be attached with mounting brackets to either the vertical upright members of the billboard or to the horizontal ledger members, wherein the track member is disposed adjacent to the various catwalks of the billboard. The track member may further comprise extended curved sections which extend into the area of the walkaround catwalk, thereby allowing a worker to be secured to the fall arrest system with a single lanyard while moving to the ladder at the walkaround catwalk, thereby eliminating the need to backtrack to disconnect the lanyard. A sliding member, such as a wheeled trolley, slidably engages the track member, the sliding member travels along or in the track member as the worker moves relative to the track member. A safety line is attached at one end to the sliding member and attached at the other end to a safety harness worn by the worker.

### BRIEF DESCRIPTION OF THE DRAWINGS

FIG. 1 depicts a commonly utilized configuration of a billboard.

FIG. 2 depicts a corner of a billboard showing the walkaround catwalk and the ladder to the upper catwalk.

FIG. 3 shows the relative positions of the lower catwalks on a commonly utilized billboard.

FIG. 4 shows a front view of a typical billboard showing the main structural members.

FIG. 5 shows a plan view of a typical two-sided billboard showing the main structural members.

FIG. 6 shows a plan view of a V-build billboard, showing the main structural members.

FIG. 7 shows the cable portion of the known fall arrest system used for billboards.

FIG. 8 schematically shows a worker suspended from a cable fall arrest system, showing the displacement in the cable when supporting the weight of the worker.

FIG. 9 shows a front view of a billboard utilizing an embodiment of the disclosed fall arrest system.

FIG. 10 shows a plan view of a two-side billboard utilizing an embodiment of the disclosed fall arrest system, showing how the rails of the fall arrest system may extend to the walkaround catwalk

FIG. 11 shows a side sectional view of a single-sided billboard showing a rail member of an embodiment of the present invention as mounted for the front and back catwalks.

FIG. 12 shows a side sectional view of a two-sided billboard showing two different means of attaching the rail members to structural members.

FIG. 13 schematically shows a worker suspended from an embodiment of the disclosed fall arrest system, showing that there is no visible displacement in the rail when supporting the weight of the worker.

FIG. 14 shows a side view of the anchor structure for the rail member of an embodiment of the disclosed fall arrest system.

FIG. 15 shows a front view of the anchor structure depicted in FIG. 14.

FIG. 16 shows a top view of the anchor structure depicted in FIG. 14, showing how the rail member extends from each side of the anchor structure.

FIG. 17 shows a trolley member which may be utilized as the sliding member which slidably engages the track member.

### DETAILED DESCRIPTION OF THE EMBODIMENTS

### Billboard Types and Components

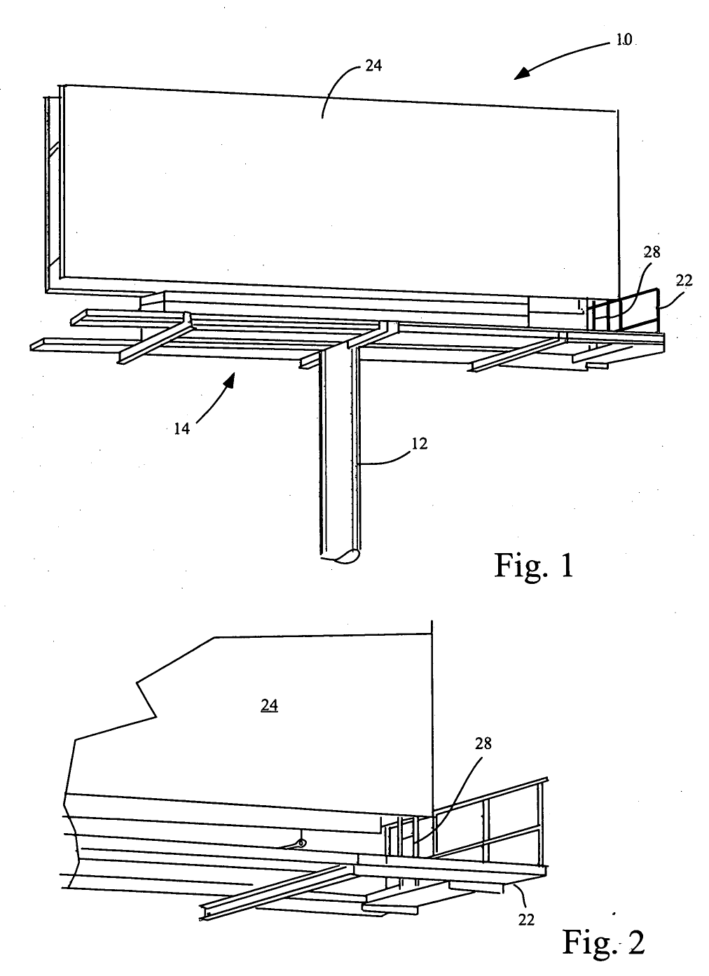

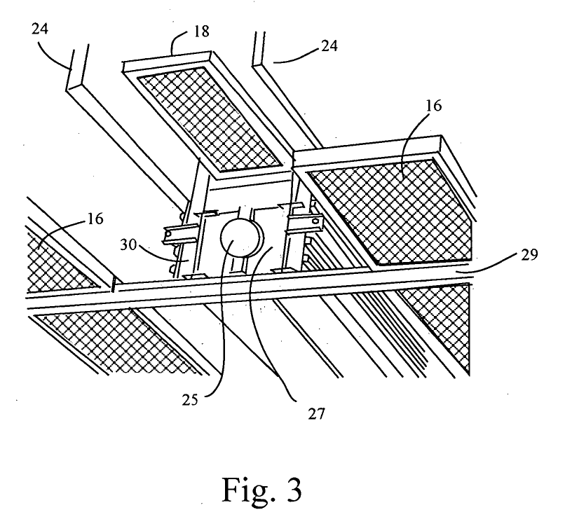

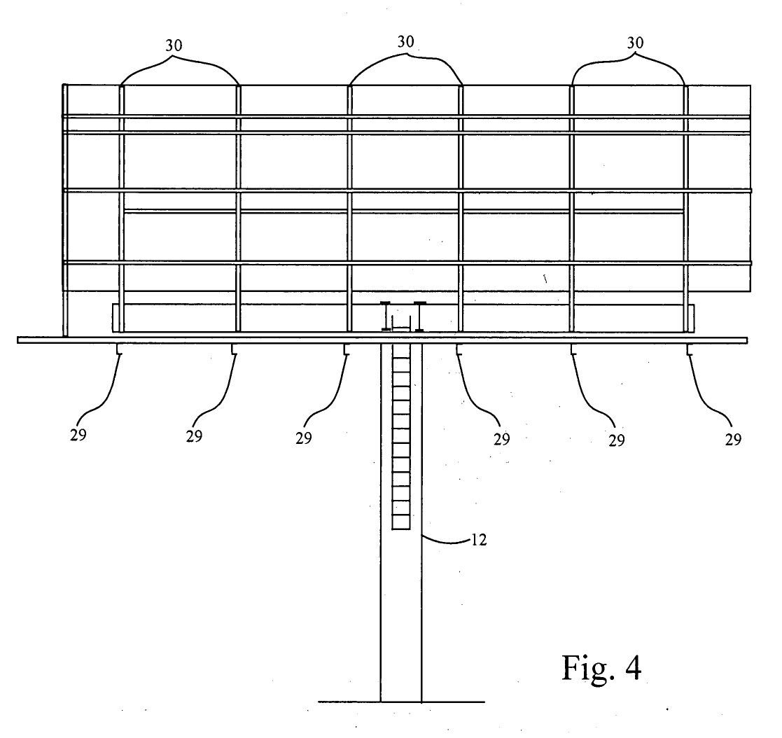

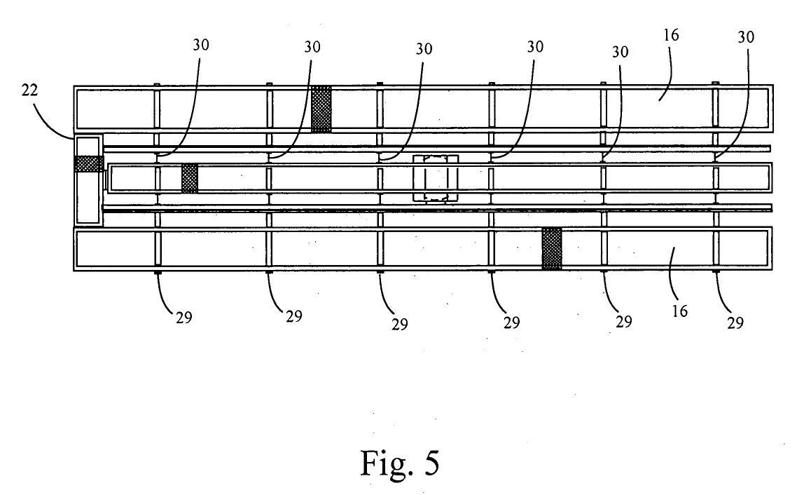

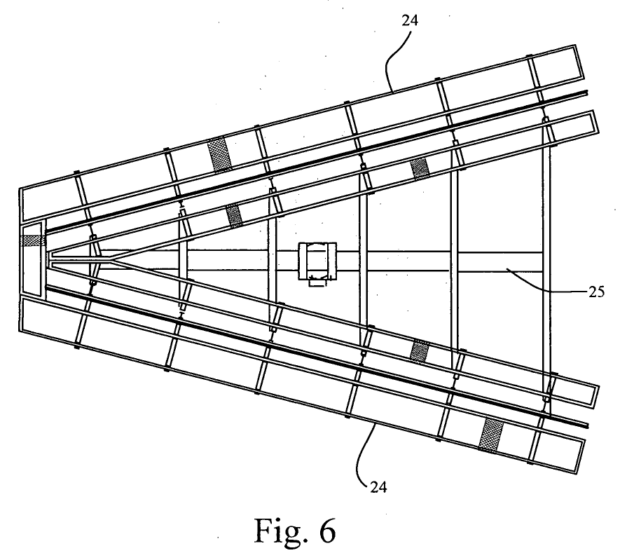

FIGS. 1 through 6 show known embodiments of billboards and billboard components. Billboards may be configured in a number of different ways to best display the information contained in the sign. For example, FIG. 1 depicts a two-sided billboard, FIG. 4 shows a single-sided billboard, and FIG. 6 shows a V-build billboard. However, despite the various designs and configurations, billboards share a number of common components and characteristics. In order to be seen, billboards must be elevated. Billboards must have sufficient structural integrity to support the weight of the components while subjected to the anticipated environmental conditions, including wind, snow accumulation, etc. In addition, billboards usually comprise structural features which facilitate access to the various sign components by workers, who may be changing out the vinyl sign from the face of the billboard, repairing lighting, or other maintenance and/or repair. As can be seen in the figures, known billboards 10 comprise elevation means, such as column pipe 12 which supports frame 14. Alternatively, the billboard 10 may be elevated by multiple I-beam members 12′.

Billboards 10 typically have multiple catwalks which allow access to the lower front of the billboard, the lower rear of the billboard, and the upper rear of the billboard. These catwalks generally comprise front catwalks 16, lower rear catwalks 18, upper rear catwalks 20, and walkaround catwalks 22. The lower rear catwalks 18 are those which are at the backside of the sign face 24. However, for two-sided billboards, there will be a front catwalk 16 in front of each sign face 24. The billboard further comprise one or more sign faces 24 and may comprise apron 26. Apron 26 is utilized to cover structural members such as vertical uprights 30, and torque tube 25, which is typically attached transversely to column pipe 12, and is the main horizontal structural member of a billboard. Workers may gain access to the upper rear catwalk 20 from the front cat walks 16 or lower rear catwalks 18 by walking to the walkaround catwalk 22 and climbing up ladder 28. The vertical uprights 30 are attached to torque tube 25 with mounting plates 27 or similar structures. The vertical uprights 30 are structural beams to which are attached ledger beams 29. The vertical uprights 30 and ledger beams 29 support the various catwalks and sign face 24.

### Prior Art Fall Arrest Systems

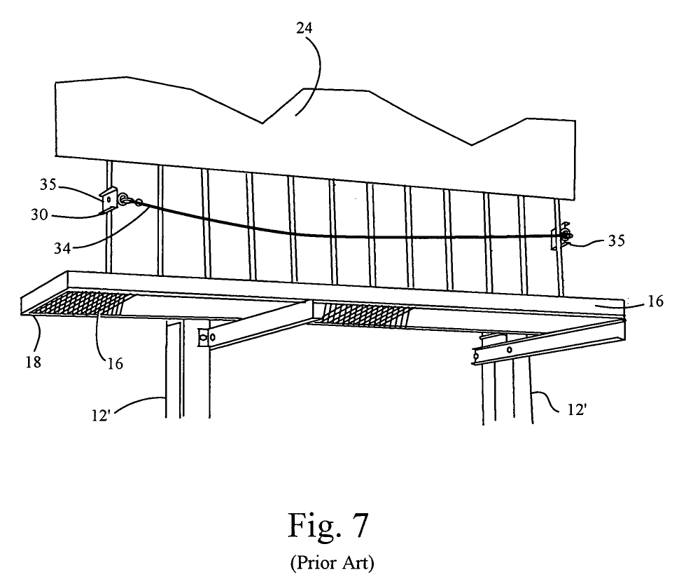

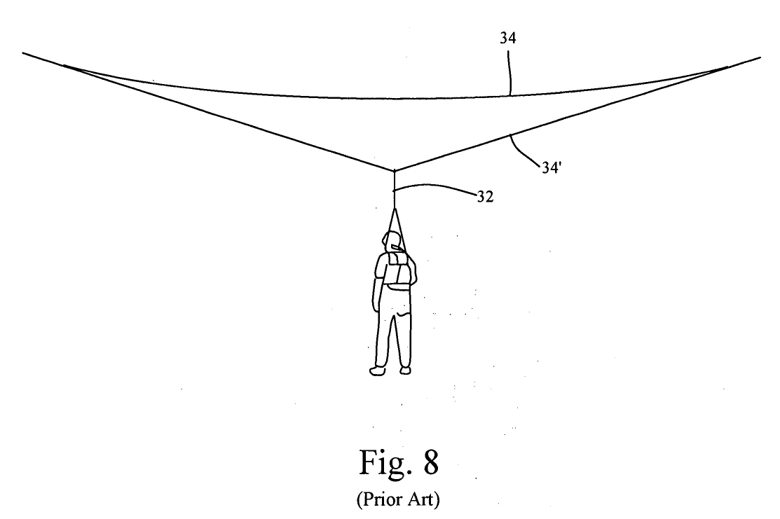

It is to be appreciated that billboards 10 are generally set at a relatively substantial height above ground to increase visibility. Because of this height, workers face a risk of falling when conducting various operations on a billboard. This risk has caused various regulatory agencies, specifically the Occupational Safety and Health Administration (OSHA) to issue various regulations pertaining to safety apparatus required for billboard workers. In general, billboard workers are required, when working on any of the billboard catwalks, to have a safety lanyard to arrest a fall from the catwalk. FIGS. 7 and 8 depict a fall arrest system widely used for billboard workers. The worker wears a harness to which a lanyard 32 is attached. The lanyard is attached to a cable 34 which spans between two of the vertical uprights 30, where the cable is attached to plate 35.

The above-described fall arrest system has several disadvantages. As shown in FIG. 7, cable 34 does not extend completely across the breadth of the catwalk, but rather spans between the outermost vertical uprights 30. If a worker needs to move from lower front catwalk 16 to upper rear catwalk 20, the worker must first move to walkaround catwalk 22 to gain access to ladder 28. However, cable 34 does not extend all of the way to the walkaround catwalk 22.

OSHA regulations require that a billboard worker always be secured to a fall arrest device while working on a catwalk. Therefore, the accepted practice is for a billboard worker to have two lanyards 32 attached to his or her harness. To gain access to ladder 28, the worker would ideally move to the walkaround catwalk 22 with a first lanyard 32 attached to cable 34, with the lanyard of sufficient length for the worker to get to the ladder 28. Once at the ladder 28, the worker would attach a second lanyard to the ladder 28 or other member, and then return to the point where the first lanyard 32 is attached to cable 34 to disconnect the first lanyard. It is to be appreciated that this is burdensome process, which encourages some workers to disconnect the first lanyard 32 and move to the ladder 28 without being secured by any fall arrest device. Lanyard 32 must be of sufficient length for the worker to move back and forth from the front catwalk 16 to the ladder 28.

The known system has other deficiencies. As best shown in FIG. 7, cable 34, because of its weight and the length it spans, has a considerable amount of sag between the anchor points at the outermost vertical uprights 30. Because of the sag, a worker may fall a considerable distance before the fall is arrested by the lanyard 32 attached to the cable 34, as shown in FIG. 8. The distance of the fall is also increased because of the need to utilize a relatively long lanyard 32 as discussed above. Moreover, as also shown in FIG. 8, if a worker falls, cable 34 is severely deflected from its original position to the position of cable 34′. This deflection not only causes the worker to fall a substantial distance before having the fall arrested, but it potentially causes other workers tethered to the cable to also fall because of the abrupt tensioning of the cable 34.

### The Present Invention

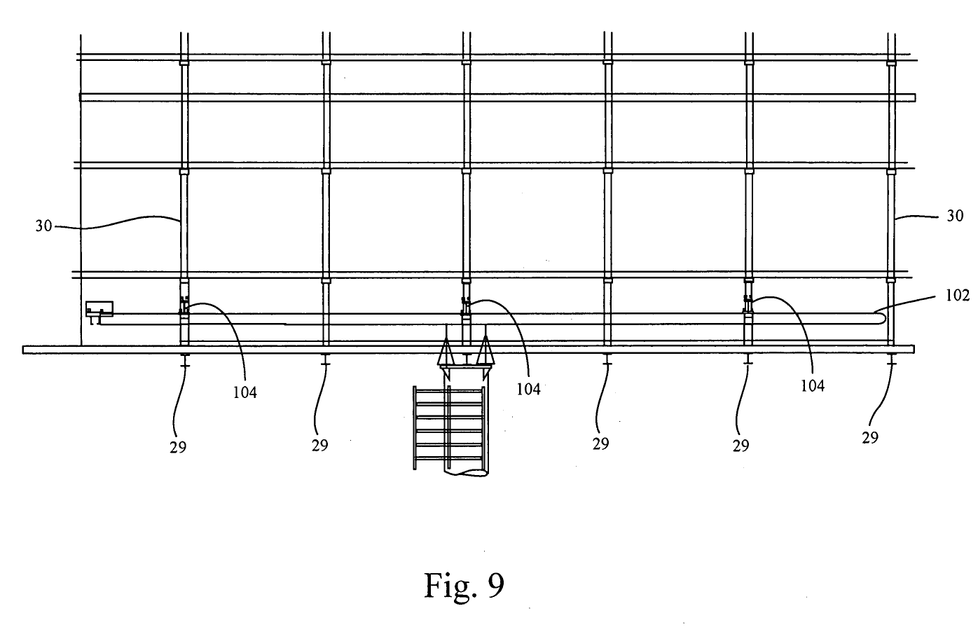

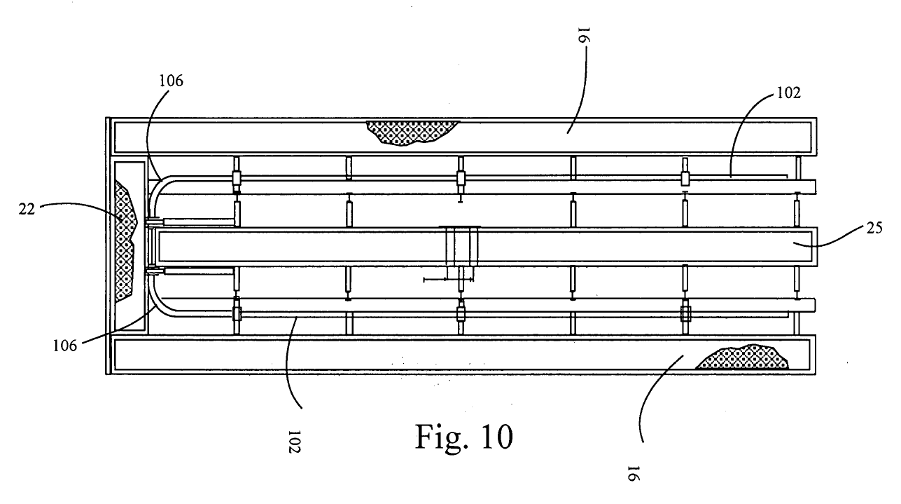

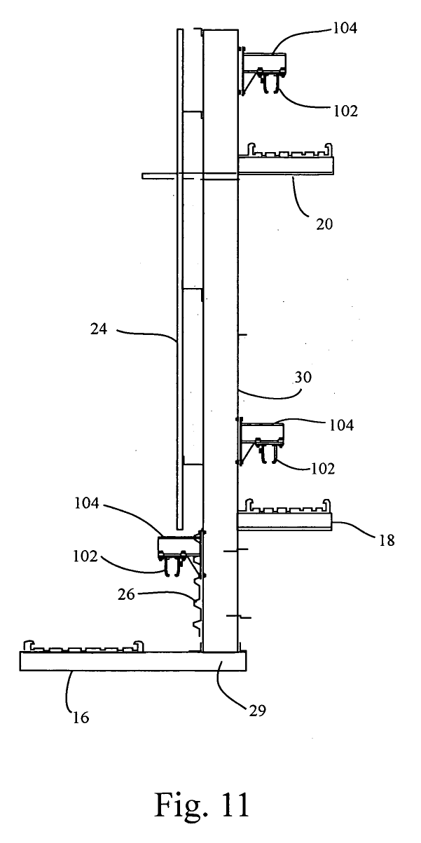

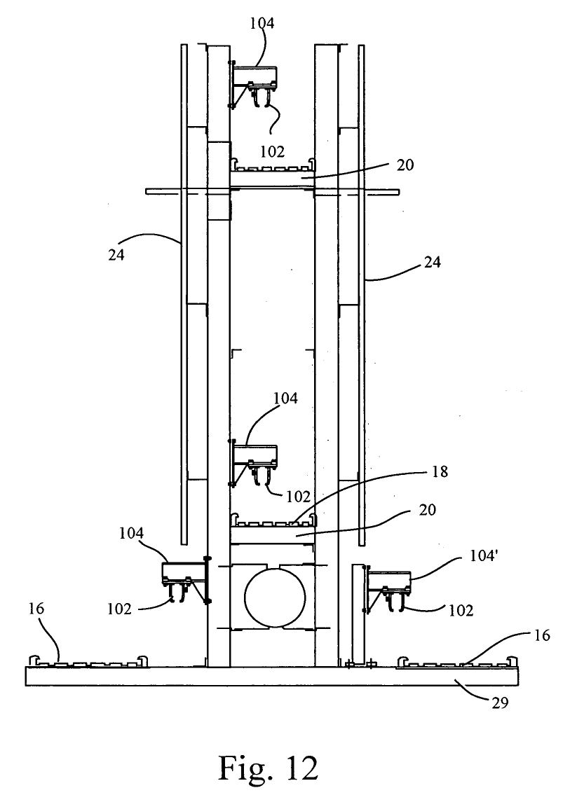

Embodiments of the various components of the fall arrest system are illustrated in FIGS. 9 through 17. The fall arrest system comprises a track member 102 which may span the entire width of the billboard 10 as shown in FIG. 9. Track member 102 may be attached to vertical uprights 30 with mounting brackets 104. Alternatively, track member 102 may be attached to mounting brackets 104′ which are attached to ledger members 29 as shown in FIG. 12. Track member 102 is attached adjacent to the various catwalk members, and is preferably attached above the catwalk members to facilitate a worker's access for connecting the safety lanyard 32′ and to prevent snagging of the lanyard 32′ with other structural components. However, it is to be appreciated that track member 102 might also be incorporated into the catwalk member or attached at the front edge of the catwalk member.

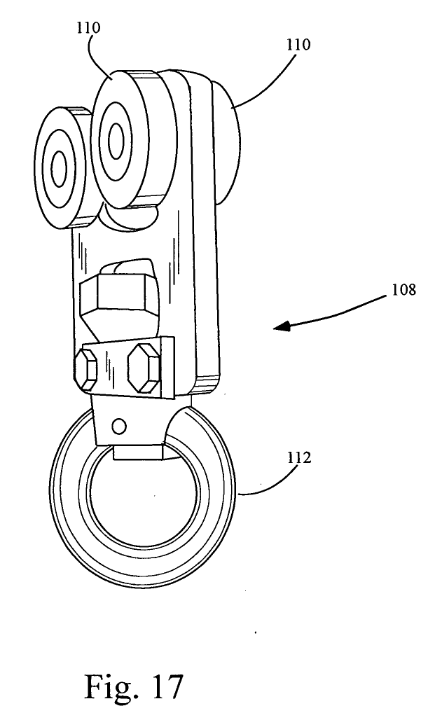

Disposed within track member 102 is sliding member 108 which moves within or on track member 102 as a worker moves from one location to another with the lanyard 32′ attached to the worker. FIG. 17 shows one type of sliding member 108, which is a trolly having wheels 110 and an a swivel eye 112 for the worker to clip on the lanyard 32′ For this sliding member 108, the wheels 110 are enclosed within track member 102. It is to be appreciated that the number and/or the configuration of the wheels may change without changing the functionality of the sliding member 108. Acceptable track members 102 and sliding members (trolleys) 108 are manufactured by SPANCO, Inc. of Morgantown, Pa. It is to be appreciated that other track members 102 and sliding members 108 may be utilized without departing from the spirit of the invention.

Track member 102 may further comprise curved section's 106 which extend into the walkaround catwalk 22. This feature allows a worker to remain attached to the fall arrest system as the worker traverses the front catwalk 16 to the walkaround catwalk 22 without the need to retrace the worker's steps back along front catwalk 16 to disengage the lanyard 32′. As discussed above, the presently used fall arrest system requires such a procedure for the worker to always have a safety line attached to the fall arrest system. A worker can simply travel to the walkaround catwalk 22, clip a second lanyard onto ladder 28, unclip the first lanyard 32′ from the sliding member 108, and then climb the ladder to the upper rear catwalks 20.

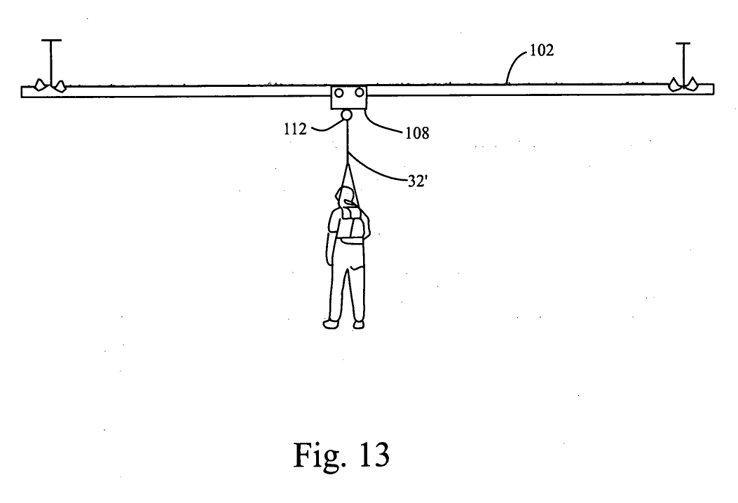

As schematically depicted in FIG. 13, the track member 102 of the presently disclosed billboard fall arrest system does not deflect in the same manner as cable 34. The lack of deflection reduces the distance a worker falls before being restrained by lanyard 32′. In addition, because of lack of deflection in track member 102, if one worker falls, other workers attached to the same track member 102 will not experience a sudden pull on lanyard 32′ as occurs with the present cable fall arrest system.

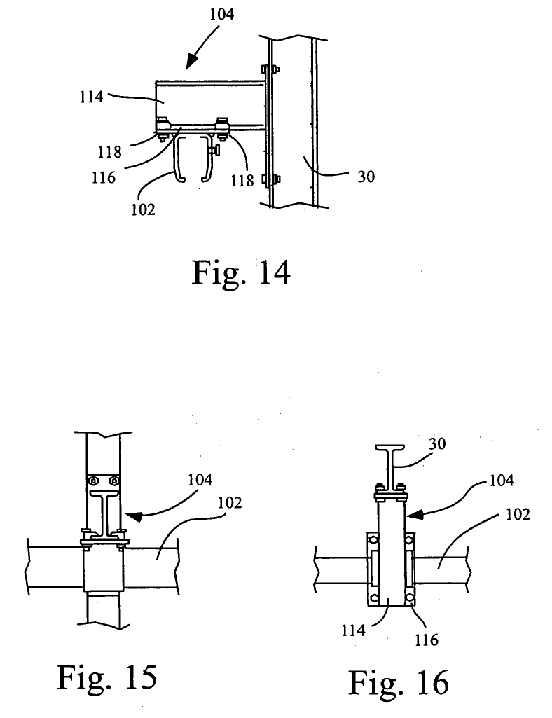

FIGS. 14 through 16 show how track member 102 may be attached to vertical uprights 30 with mounting brackets 104. Mounting bracket 104 comprises beam member 114 and attachment plate 116. As shown in FIG. 14, track member 102 may have outwardly extending flanges 118 which may be bolted to attachment plate 116. As best shown in FIG. 14, track member 102 may comprise opposite facing rail members wherein a pair of wheels 110 on each side of the sliding member 108 are disposed. The rail members may have upwardly turning edges for retaining the wheels within each member.

While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed. Instead the true scope of the invention should be determined by the following claims.

What is claimed is:

1. In an elevated billboard comprising a vertical support member, a horizontal member attached to the upper end of the vertical support member, a plurality of vertical upright members attached to the horizontal member, a sign face attached to the vertical upright members, a horizontal ledger member attached to each vertical upright member, and a catwalk member attached transversely to the horizontal ledger members, the catwalk member utilized by a worker accessing the sign face, a personnel fall arrest system comprises:
a track member spanning between the vertical upright members, the track member disposed adjacent to the catwalk member;
a sliding member slideably engaging the track member; and
a safety line having a first end and a second end, the first end attached to the sliding member and the second end attached to a safety harness worn by the worker.

2. The fall arrest system of claim 1 wherein the track member is disposed above the catwalk member.

3. The fall arrest system of claim 1 wherein the sliding member is disposed within the track member.

4. The fall arrest system of claim 2 wherein the track member is attached to a mounting bracket, and the mounting bracket is attached to one of the vertical upright members.

5. The fall arrest system of claim 1 wherein the track member comprises opposite facing rail members.

6. The fall arrest system of claim 5 wherein the sliding member comprises wheels on each side of the sliding member, wherein the wheels are disposed within the rail members.

7. In an elevated billboard comprising a vertical support member, a horizontal member attached to the upper end of the vertical support member, a plurality of vertical upright members attached to the horizontal member, a sign face attached to the vertical upright members, a horizontal ledger member attached to each vertical upright member, and a catwalk member attached transversely to the horizontal ledger members, the catwalk member utilized by a worker accessing the sign face, a personnel fall arrest system comprises:
a track member spanning between the horizontal ledger members, the track member disposed adjacent to the catwalk member;
a sliding member slideably engaging the track member; and
a safety line having a first end and a second end, the first end attached to the sliding member and the second end attached to a safety harness worn by the worker.

8. The fall arrest system of claim 7 wherein the track member is attached to a mounting bracket, and the mounting bracket is attached to one of the horizontal ledger members.

9. In an elevated billboard comprising a vertical support member, a horizontal member attached to the upper end of the vertical support member, a first plurality of vertical upright members attached to a first side of the horizontal member, a second plurality of vertical upright members attached to a second side of the horizontal member, a first sign face attached to the first plurality of vertical upright members, a second sign face attached to the second plurality of vertical upright members, a first plurality of horizontal ledger members attached to each vertical upright member of the first plurality of vertical upright members, and a second plurality of horizontal ledger members attached to each upright member of the second plurality of vertical upright members, a first catwalk member attached transversely to the first plurality of horizontal ledger members, a second catwalk member attached transversely to the second plurality of horizontal ledger members, and a walk-around member connecting the first catwalk member to the second catwalk member, the catwalk members and walk-around member utilized by a worker accessing the first sign face and the second sign face, a personnel fall arrest system comprises:
a track member spanning between and attached to the vertical upright members, the track member disposed adjacent to the first catwalk member, the second catwalk member, and the walk-around member;
a sliding member slideably engaging the track member; and
a safety line having a first end and a second end, the first end attached to the sliding member and the second end attached to a safety harness worn by the worker.
